(19) United States
(12) Patent Application Publication
(10) Pub. No.: US 2026/0125129 A1
(43) Pub. Date: May 7, 2026

(54) SYSTEM FOR AN ELECTRIC BICYCLE, ELECTRIC BICYCLE, COMPONENT FOR AN ELECTRIC BICYCLE, AND KIT FOR AN ELECTRIC BICYCLE

(71) Applicant: Porsche eBike Performance GmbH, Ottobrunn (DE)

(72) Inventors: Ivor Mikolcevic, Zagreb (HR); Hinko Zlopasa, Velika Gorica (HR)

(21) Appl. No.: 19/379,462

(22) Filed: Nov. 4, 2025

(30) Foreign Application Priority Data
Nov. 4, 2024 (DE) 10 2024 132 024.9

(51) Int. Cl. B62H 5/00

(52) U.S. Cl. CPC B62H 5/001

(57) ABSTRACT

In at least one embodiment, a system for an electric bicycle includes a first component and a second component. The first component and the second component are connected to each other via a closed locking mechanism. The locking mechanism can be opened via a magnetic field and/or an electric field provided by a tool.

### CROSS-REFERENCE TO RELATED APPLICATIONS

This application claims priority of German patent application no. 102024132 024.9, filed November 4, 2024, the entire content of which is incorporated herein by reference.

### TECHNICAL FIELD

A system for an electric bicycle is described. In addition, an electric bicycle, a component for an electric bicycle, a kit for an electric bicycle, a method for assembling a system for an electric bicycle, and a method for disassembling a system for an electric bicycle are described.

### BACKGROUND

Bicycles are a cost-effective, easy-to-use, and emission-free means of transportation. They have also become popular as sports and fitness equipment, and certain types have proven to be particularly suitable for different athletic applications.

In recent years, enthusiasm for electric bicycles (especially so-called “pedelecs”) has been growing, despite their high weight and price compared to conventional bicycles. With electric bicycles, it is important to protect important and expensive components from theft.

### SUMMARY

One task to be solved is to provide a system for an electric bicycle that contributes to reliable theft protection. Further tasks to be solved are to specify an electric bicycle with such a system, a component for such a system, a kit for such a system, and a method for assembling and disassembling such a system.

First, the system for an electric bicycle is specified.

In at least one embodiment, the system for an electric bicycle includes a first component and a second component. The two components are connected to each other via a closed locking mechanism. The locking mechanism can be opened via a magnetic and/or electric field provided by a tool.

The present disclosure is based, among other things, on the realization that a locking mechanism that can be opened using a magnetic and/or electric field can be installed in a particularly inconspicuous manner, in particular, it can be completely hidden. This is not only advantageous for visual reasons, but can actually contribute to greater protection against theft. A potential thief may not recognize where exactly the locking mechanism is located and therefore does not know where to apply the tool.

The first and second components are components of the electric bicycle or for the electric bicycle. For example, at least one of the two components is an electronic component, that is, it includes electronics. The two components can be connected to each other exclusively via the locking mechanism, so that opening the locking mechanism allows one component to be completely detached from the other. Alternatively, in addition to the connection via the locking mechanism, there may also be another connection, for example a permanent connection. Opening the locking mechanism would then allow one component to be moved relative to the other component but not to be completely detached. The additional connection could be a hinge connection, for example.

In the system, the locking mechanism is in a closed state, that is, the locking mechanism is closed or locked. The locking mechanism contributes at least to a connection between the first component and the second component. The locking mechanism is therefore a connecting or coupling mechanism. When the locking mechanism is in the closed state, the connection established by the locking mechanism is secured, that is, it cannot be released. In other words, the two components are locked or latched together by the locking mechanism. In particular, the connection established by the closed locking mechanism cannot be released without damage without the use of a suitable tool. The locking mechanism can also be referred to as a latching mechanism.

The locking mechanism is configured so that it can be opened using a suitable tool. The tool is a key for the locking mechanism. The opening is performed using an electric and/or magnetic field of the tool. To do this, the tool is brought close to the locking mechanism so that the locking mechanism is at least partially within a region of the magnetic and/or electric field in which the field strength is sufficiently high to open it. The locking mechanism can be opened using solely the magnetic and/or electric field provided by the tool. In other words, the locking mechanism can be opened magnetically and/or electrically. For example, the locking mechanism includes a movable element that is moved by a force generated by the magnetic and/or electric field of the tool. The movement then opens the locking mechanism, for example.

The tool is a tool that can be handled separately from the locking mechanism. In particular, the magnetic and/or electric field provided by the tool is an external field in relation to the locking mechanism, that is, it is not provided by the locking mechanism itself.

For example, the locking mechanism can be opened without contact using the tool, that is, the tool does not have to be brought into contact with the locking mechanism to open it, but can be held at a distance from the locking mechanism. For example, the locking mechanism opens even when the tool is 1 cm, 5 cm, or 10 cm away from the locking mechanism. The fact that the locking mechanism can be opened without contact does not preclude the tool from being brought into direct contact with one of the components of the system in order to actually open the locking mechanism.

According to at least one embodiment, the locking mechanism includes a first locking element, which is associated with the first component, and a second locking element, which is associated with the second component. The first locking element is, for example, attached to the first component or is part of the first component. Similarly, the second locking element may be attached to the second component or be part of the second component. For example, the first and/or second locking elements may be connected to the respective component by form-fit and/or force-fit, for example via a screw connection, or by material-fit, for example via a welded or adhesive connection. The first and/or second locking elements may also be pressed into the respective component.

According to at least one embodiment, the locking elements are coupled to each other. In particular, the locking elements engage with each other. The locking elements can be inserted into each other.

According to at least one embodiment, the locking mechanism is configured in such a way that decoupling of the two locking elements is blocked when the locking mechanism is in the closed state. For example, decoupling is blocked by a force fit and/or form fit.

According to at least one embodiment, the locking mechanism is configured such that the blocking of the decoupling can be released via the magnetic and/or electric field provided by the tool, thereby opening the locking mechanism. In particular, the blocking can be released solely by the magnetic and/or electric field provided by the tool.

According to at least one embodiment, the locking mechanism includes a blocking element. The blocking element may be part of the first locking element or the second locking element. When the locking mechanism is closed, the blocking element is in a first position and blocks the decoupling of the two coupled locking elements. With the help of the magnetic and/or electric field provided by the tool, the blocking element can be moved from the first position to a second position, in which the blocking element no longer blocks the release of the coupling between the first and second locking elements, that is, it releases it.

According to at least one embodiment, the locking mechanism is configured so that it can be opened magnetically. This means that the locking mechanism can be opened using a magnetic field provided by the tool. The magnetic field is, in particular, a time-constant magnetic field. Respective, the tool is a magnet or includes a magnet. In particular, the tool includes a permanent magnet or consists thereof.

For example, the blocking element is forced from the first position to the second position by the magnetic field of the tool. For example, the blocking element includes or consists of ferromagnetic material. The blocking element may be permanently magnetized.

The magnetic material of the tool is, for example, a neodymium material, in particular neodymium-iron-boron. The tool has, for example, a magnetic holding force of at least 1 kg or at least 5 kg or at least 10 kg.

According to at least one embodiment, one of the two locking elements is a plug. The other of the two locking elements is a receptacle for the plug or a female counterpart to the plug. This means that the plug can be inserted into the other locking element. The other of the two locking elements includes, for example, a receptacle element or receptacle container with an opening through which the plug is inserted into the receptacle element. The receptacle element can be configured as a cup, can, or socket. The plug can be, for example, a pin, a spike, or a needle.

The receptable element or a wall of the receptable element surrounds the inserted plug azimuthally and tapers, for example, in the axial direction, that is, in the direction in which the plug is inserted or pulled out, in order to couple or decouple the two locking elements. For example, the receptable element is conically shaped at least in sections. The blocking element can be a ball in the receptable element that can be moved magnetically and/or electrically within the receptable element using the tool. For example, the locking mechanism includes two or more blocking elements, for example each in the form of a ball. When the locking elements are coupled, the balls can be arranged around the plug. For example, in the first position, the balls rest against both the plug and the wall of the receptable element in the tapered area. When attempting to pull the plug out of the receptable element in the axial direction through the opening, the balls jam with the plug and the wall, so that pulling out is blocked. This results in self-locking.

With the aid of the tool, the balls can then be forced into the second position, for example, whereby they lose contact with the wall and/or the plug. In particular, the tool can be used to move the balls in a direction in which the conical section of the receptable element becomes wider. Pulling out the plug is then no longer blocked.

According to at least one embodiment, the first component is a control unit for an electric motor of the electric bicycle. The first component includes, for example, an interface for communication with the electric motor. For example, the first component includes a socket or receptacle for a plug connection with a cable to the electric motor or an intermediate component. The first component may be or include a so-called VCU (Vehicle Control Unit). The VCU is a control unit for the electric bicycle. The first component includes, for example, a display for displaying data such as the charge level of a battery of the electric bicycle or an operating mode of the electric motor or of the electric bicycle.

According to at least one embodiment, the second component is a frame element of the electric bicycle. The frame element can be part of the bicycle frame. For example, the second component is a top tube of the electric bicycle. Alternatively, the second component can also be a mounting frame for the first component, whereby the mounting frame is/will be inserted into the bicycle frame.

According to at least one embodiment, the system is configured so that the first component can be detached from the second component or vice versa by opening the locking mechanism. In particular, there is no other connection between the components apart from the connection established by the locking mechanism.

According to at least one embodiment, a receptacle for the first component is provided in the second component. The receptacle is, for example, a hole or a recess or a cavity in the second component. The first component is arranged in the receptacle of the second component. For example, the first component is arranged in the receptacle of the second component in such a way that it is flush with the second component at the opening to the receptacle. Alternatively, the first component may protrude from the opening to the receptacle. In particular, for example, at least 60% or at least 70% or at least 80% of the volume of the first component is arranged within the receptacle of the second component. The opening to the receptacle is, for example, directed upwards, that is, away from the ground or the road. The rider of the bicycle can, for example, see the first component, in particular its display, while riding.

According to at least one embodiment, one of the two components has a tensioned spring element. The tensioned spring element bears against the other component, thereby holding the first component in the receptacle of the second component. This means that the spring element exerts a force on the first component that attempts to push the first component further into the receptacle away from the opening to the receptacle. The spring force thus holds the first component firmly in the receptacle.

According to at least one embodiment, when the locking mechanism is opened, the spring element pushes the first component out of the receptacle of the second component so that the first component can be removed from the receptacle. This means that when the locking mechanism is opened, the force exerted by the spring element automatically pushes the first component out of the receptacle, that is, moves it out at least a little way.

For example, the system is configured so that the spring element exerts a lever force at one end of the first component, which is directed in such a way that it attempts to push an opposite end of the first component out of the receptacle. The first component is supported at a tipping point between the two opposite ends. The end opposite the spring element is secured against being pushed out when the locking mechanism is closed. As a result, when the locking mechanism is closed, the spring element ensures that the first component is held firmly in the receptacle. Only by opening the locking mechanism is the end of the first component opposite the spring element released so that it can be pushed out. This mechanism makes it particularly easy to remove the first component from the receptacle of the second component.

According to at least one embodiment, the spring element is a spring arm on the first component. For example, the spring element is a spring arm on a longitudinal end of the first component. In particular, the first component may be elongated. The spring arm has a curved shape, for example. It can be made of plastic or metal.

According to at least one embodiment, the receptacle has an opening through which the first component is inserted into the receptacle or through which the first component can be removed from the receptacle. The opening is surrounded and bounded laterally by a section of the second component. The receptacle or a cavity of the receptacle extends, for example, to below this section of the second component. This means that, in top view of the opening, the section of the second component covers part of the receptacle or its cavity.

According to at least one embodiment, the spring arm extends at least partially below this section, bears against it, and is thereby tensioned. This means that the spring arm extends within the receptacle to below this section of the second component. In top view of the opening of the receptacle, the spring arm thus presses against a section of the second component that is covered by the second component. If the second component is a frame element of the electric bicycle, the frame element is hollow and the spring element is supported within the cavity in the frame element.

The arrangement described above allows the spring arm to push the first component out of the receptacle particularly easily when the locking mechanism is opened.

According to at least one embodiment, the elements of the locking mechanism, in particular the first and second locking elements and the at least one blocking element, are not freely visible. In particular, they are covered by the first component and/or the second component.

According to at least one embodiment, the locking mechanism includes several first locking elements at different locations on the first component and several second locking elements at second locations on the second component that match the first locations. The first locking elements are coupled with the second locking elements. In this context, “second locations that match the first locations” means that the second locations are selected such that the first and second locking elements can be coupled to each other. In particular, each first locking element is uniquely assigned a second locking element. Each of the first locking elements can be configured as the first locking element described above. Similarly, each of the second locking elements can be configured as the second locking element described above.

According to at least one embodiment, the locking mechanism is configured so that it can be opened by a tool including an arrangement of (permanent) magnets which corresponds to the arrangement of the locking elements. For example, the locking mechanism can only be opened non-destructively with the aid of such a tool. The use of multiple first and second locking elements further increases security against theft of the first component or the second component, because a potential thief would need to know the geometric arrangement of the interlocking locking elements in order to provide a suitable tool or key. However, since the locking elements are hidden, for example, this is not easily possible.

Next, the electric bicycle is described. The electric bicycle includes a system according to one of the embodiments described herein. All features disclosed for the system are also disclosed for the electric bicycle and vice versa.

Next, the component for an electric bicycle is specified. The component is, in particular, one of the components described in connection with the system, that is, a component of this system or for this system. All features disclosed in connection with the system are thus also disclosed for the component and vice versa.

In at least one embodiment, the component for an electric bicycle includes a locking element for coupling with a further locking element of a further component. The locking element is intended for a locking mechanism which, when closed, connects the two components to each other via the coupling between the two locking elements. The locking mechanism is configured so that it can be opened using a magnetic and/or electric field provided by a tool.

The locking element of the component includes, for example, the movable blocking element(s) and/or the at least partially conical can or socket. The blocking element(s) are accommodated in particular in the socket.

Next, the kit for an electric bicycle is described. The kit is intended in particular for manufacturing the system described herein. All features disclosed in connection with the system are therefore also disclosed for the kit and vice versa.

In at least one embodiment, the kit includes a first component with a first locking element and a second component with a second locking element. The locking elements are part of a locking mechanism that is configured to be closed by coupling the two locking elements and, in its closed state, blocks the two locking elements from being decoupled. In addition, the locking mechanism can be opened using a magnetic and/or electric field provided by a tool.

Unlike in the system, the components of the kit are not yet connected to each other via the locking mechanism and can, for example, be handled individually and independently of each other. The locking mechanism is configured, for example, so that in the absence of a sufficiently strong external magnetic and/or electric field, such as that provided in particular by the tool, it closes automatically when the two locking elements are coupled. This means that no tool is required to close the locking mechanism. Rather, the coupling, for example, interlocking, of the locking elements leads to closure on its own.

According to at least one embodiment, the kit further includes the tool described herein for opening the locking mechanism. The tool is separate from the first and second components, that is, it is not connected to them.

Next, the method for assembling the system is described. The method is particularly suitable for manufacturing the system described here from the kit described here. All features disclosed in connection with the system and the kit are also disclosed for the method for assembling and vice versa.

In at least one embodiment, the method for assembling includes a step of providing the kit according to one of the embodiments described herein. The two locking elements are then coupled to each other to connect the two components.

Next, the method for disassembling a system is described. In particular, the method is suitable for disassembling the system according to one of the embodiments described herein. In this respect, all features disclosed for the system are also disclosed for the method and vice versa.

In at least one embodiment, the method for disassembling a system for an electric bicycle includes providing a system according to one of the embodiments described herein. The tool is then positioned over the first and/or second component. The first component is then detached from the second component or vice versa.

Positioning the tool over the first and/or second component opens, in particular, the locking mechanism. Positioning the tool over the first and/or second component also includes positioning the tool on the first and/or second component, that is, bringing the tool into direct contact with the first and/or second component.

### BRIEF DESCRIPTION OF DRAWINGS

The invention will now be described with reference to the drawings wherein: FIG. 1 shows an exemplary embodiment of an electric bicycle,

FIG. 2 shows a position in an exemplary embodiment of the method for assembling the system,

FIG. 3 shows an exemplary embodiment of the system,

FIG. 4 shows a position in an exemplary embodiment of the method for disassembling the system,

FIG. 5 shows a position in another exemplary embodiment of the method for assembling the system,

FIG. 6 shows another exemplary embodiment of the system,

FIG. 7 shows a position in another exemplary embodiment of the method for disassembling the system,

FIG. 8 shows a detailed view of an exemplary embodiment of the locking mechanism in the closed state,

FIG. 9 shows a detailed view of the locking mechanism during the opening of the locking mechanism.

### DETAILED DESCRIPTION

FIG. 1 schematically shows an electric bicycle 100 with a bicycle frame 25. A control unit 1 for the electric bicycle 100 (Vehicle Control Unit, VCU for short) is arranged in the top tube 2 of the bicycle frame 25. The combination of the top tube 2 and the control unit 1 forms a system within the meaning of the present disclosure. A bottom bracket 5 including a pedal shaft 6 is provided in the lower frame section 2a, which forms a down tube 2a. An electric motor is arranged in the bottom bracket 5. This is controlled, for example, via the control unit 1. A cable from the control unit 1 to the electric motor is arranged, for example, inside the bicycle frame 25.

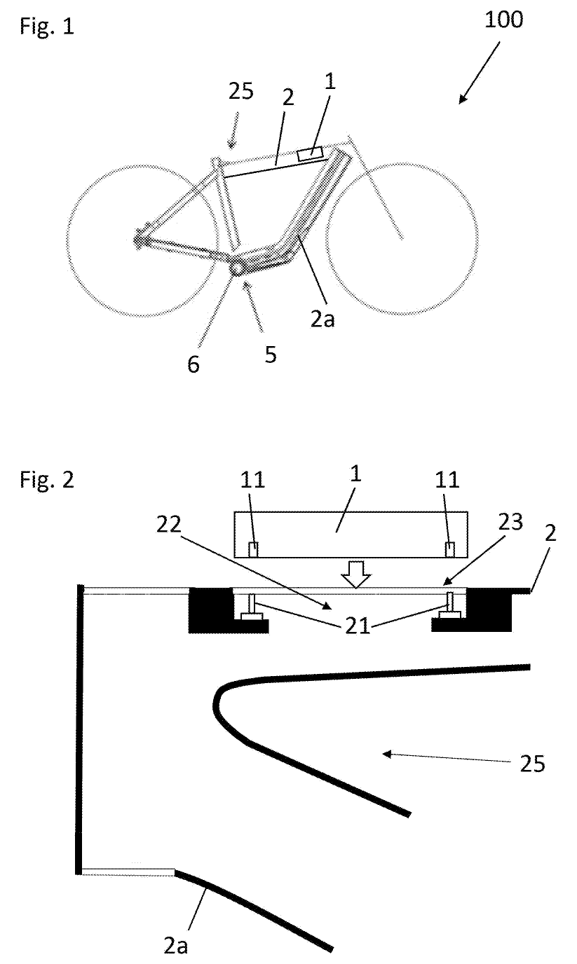

FIG. 2 shows a position in an exemplary embodiment of the method for assembling a system. Here, an exemplary embodiment of the kit is provided, which includes a first component 1 in the form of the control unit 1 and a second component 2 in the form of the top tube 2. However, the first 1 and second 2 components could also be other components of the electric bicycle, for example, an electronic control unit and a handlebar of the bicycle.

FIG. 2 shows the bicycle frame 25 in a cross-sectional view, showing the top tube 2 and the down tube 2a and the area where the top tube 2 and the down tube 2a are connected. The top tube 2 and the down tube 2a are each hollow. A receptacle 22 is provided in the top tube 2 of the bicycle frame 25. The receptacle 22 is accessible via an opening 23 in the top tube 2. Inside the top tube 2, there are support surfaces, each of which has a (second) locking element 21 in the form of a plug, pin, or spike. The plugs 21 are, for example, screwed into the support surfaces. In order to prevent the plugs 21 from coming loose while riding, the plugs 21 can be screwed into the support surfaces with the aid of lock washers, for example spring washers with two coils.

The first component 1 includes first locking elements 11 that match the second locking elements 21. The locking elements 11 are receptacles for the plugs 21. A possible structure of these receptacles 11 is described in connection with FIG.s 8 and 9.

FIG. 2 shows a position of the method in which the first component 1 is inserted into the receptacle 22 of the second component 2, thereby coupling the locking elements 11 with the locking elements 21. This automatically closes a locking mechanism.

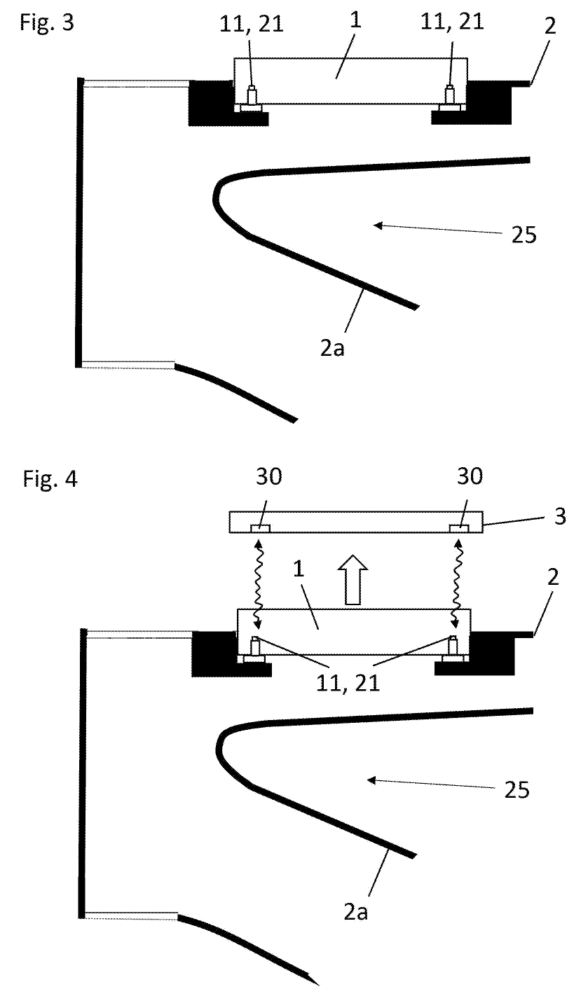

The result after coupling the locking elements 11, 21 is shown in FIG. 3, which also shows an exemplary embodiment of the system. Due to the closed locking mechanism, the first component 1 is firmly and securely coupled to the second component 2, and in particular locked to it. It is now not possible to simply remove the first component 1 from the second component 2. Instead, a special tool is required for this purpose.

FIG. 4 shows a position in an exemplary embodiment for disassembling the system of FIG. 3. For this purpose, the special tool 3 is provided, which here includes two magnets 30. The arrangement of the magnets 30 is selected in respective relation to the arrangement of the two pairs of coupled locking elements 11, 21. By positioning the tool 3 above or in contact with the first component 1, the magnetic fields of the two magnets 30 simultaneously act with high field strength on the two pairs of coupled locking elements 11, 21. The magnetic field opens the locking mechanism. The first component 1 can then be detached from the second component 2.

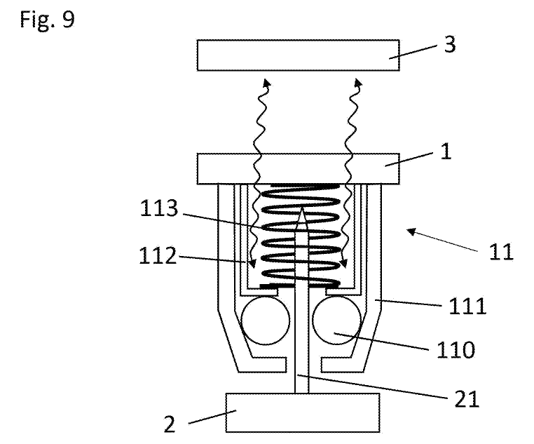

An example of how such an automatically closing and magnetically openable locking mechanism is constructed is shown in FIGS. 8 and 9. FIGS. 8 and 9 each show a pair of locking elements 11, 21. Locking element 11 includes a receptable element 111 in the form of a socket or bushing with a conical section and an opening in the narrowest area of the conical section. The plug or pin 21 is guided through this opening. The locking element 11 further includes two or three or more blocking elements 110 in the form of ferromagnetic balls, which are arranged within the receptable element 111 around the inserted pin 21 and bear against both the pin and a wall of the conical section. A piston 112 within the receptable element 111 is pressed against the balls 110 in the direction of the second component 2 via a spring 113, so that the balls 110 are held in their respective first positions as shown.

If the first component 1 is to be pulled out of the second component 2, this is prevented by the balls 110 being in contact with the pin 21 and the wall of the receptable element 111. In fact, the balls 110 jam with the plug 21 and the wall (self-locking), blocking the plug 21 from being pulled out of the receptable element 111 and making it impossible to do so even with considerable force.

However, if, as shown in FIG. 9, a tool 3 containing a magnetic material is brought close to the coupling between the two locking elements 11, 21, the balls 110 can be moved away from the second component 2 into a respective second position against the restoring force of the spring 113 if the magnet is sufficiently strong. In doing so, the balls 110 lose contact with the wall of the receptable element 111 and/or with the plug 21, thereby enabling the plug 21 to be pulled out from the receptable element 111. In this way, the locking mechanism can be opened contactlessly and magnetically.

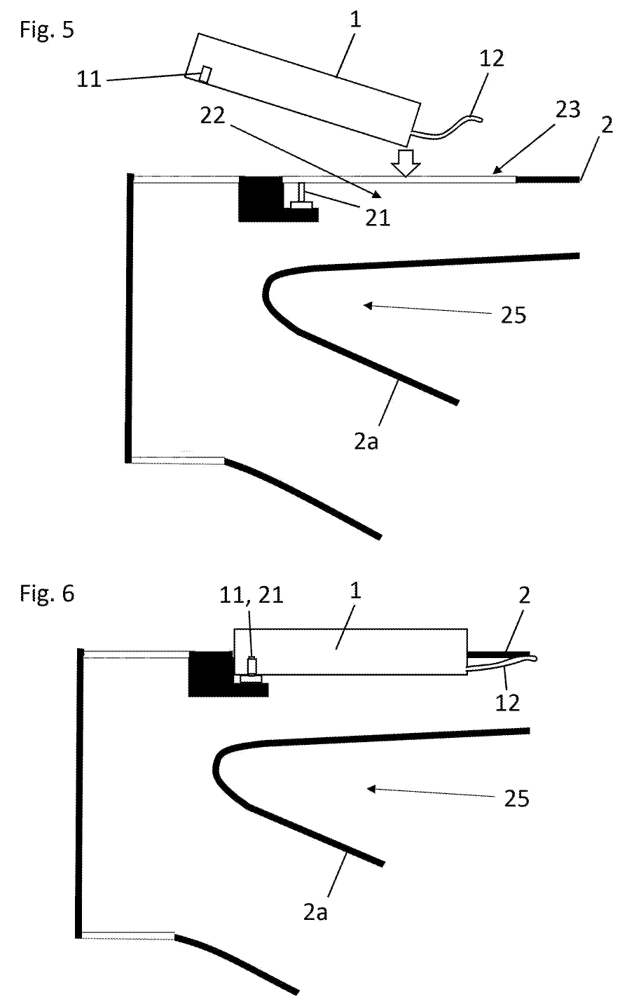

FIG. 5 shows another exemplary embodiment for assembling a system. Here, too, an exemplary embodiment of a kit is provided, which includes a control unit as a first component 1 and a top tube 2 of a bicycle frame 25 as a second component 2. Unlike in the previous exemplary embodiment, the first component 1 includes only one locking element 11, and likewise, the second component 2 includes only one locking element 21. The first component 1 includes a spring element 12 in the form of a spring arm 12 at a longitudinal end facing away from the locking element 11. The first component 1 can now be inserted obliquely through the opening 23 into the receptacle 22 in the top tube 2, whereby the spring arm 12 can be brought under the section of the top tube 2 surrounding the opening 23. In addition, the two locking elements 11, 21 can be coupled together to close the locking mechanism.

The result after inserting the first component 1 into the receptacle 22 of the second component 2 is shown in FIG. 6. The two locking elements 11, 21 are coupled together and the locking mechanism is closed. The spring arm 12 bears against the second component 2 within the receptacle 22 and is tensioned. This exerts a force on the first component 1, which additionally holds the first component 1 in the receptacle 22.

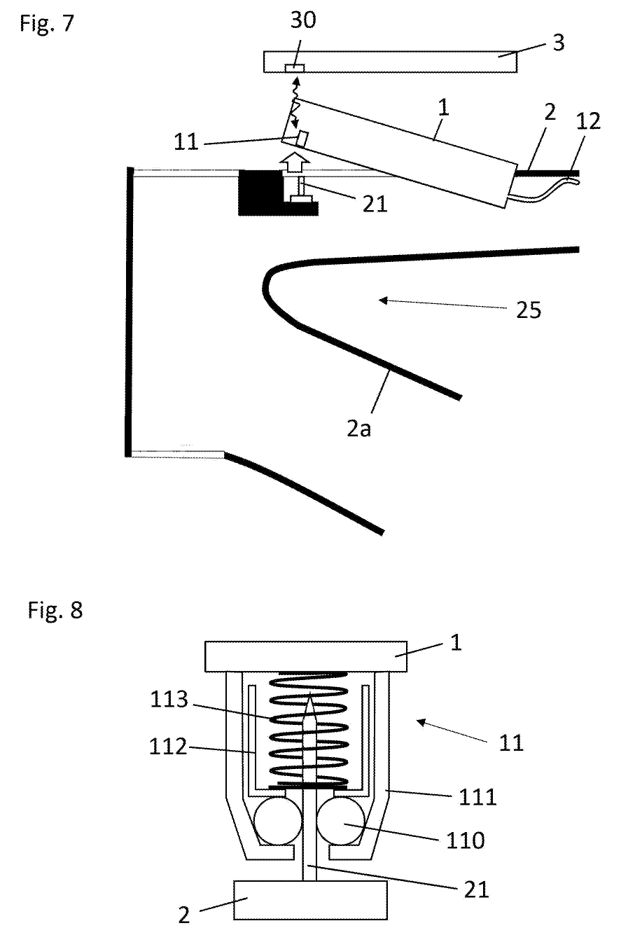

FIG. 7 shows a position in an exemplary embodiment of the method for disassembling the system of FIG. 6. Here, too, a tool 3 is provided, which includes a magnet 30. The tool 3 can be used to magnetically open the closed locking mechanism. Opening the locking mechanism allows the two locking elements 11, 21 to be decoupled. The preloaded spring arm 12 ensures that the longitudinal end of the first component 1 opposite the spring arm 12 is automatically pushed out of the receptacle 22. This makes it even easier to remove the first component 1 from the second component 2.

It is understood that the foregoing description is that of the preferred embodiments of the invention and that various changes and modifications may be made thereto without departing from the spirit and scope of the invention as defined in the appended claims.

### List of reference signs

1 first component

2 second component

3 tool

5 bottom bracket

6 pedal shaft

11 first locking element

12 spring element

21 second locking element

22 receptable

23 opening

25 bicycle frame

30 magnet

100 electric bicycle

110 ball

111 receptable element

112 piston

113 spring

1. A system for an electric bicycle, the system comprising:
a first component;
a second component;
said first component and said second component being connected to each other via a locking mechanism which is closed; and,
said locking mechanism is openable via at least one of a magnetic field and an electric field provided by a tool.

2. The system of claim 1, wherein:
said locking mechanism includes a first locking element associated with said first component;
said locking mechanism includes a second locking element associated with said second component;
said first locking element and said second locking element being coupled to each other; and,
said locking mechanism being configured such that when the locking mechanism is in the closed state, decoupling of said first locking element and said second locking element is blocked, wherein the blocking of the decoupling is releasable via the at least one of the magnetic field and the electric field provided by the tool, thereby opening said locking mechanism.

3. The system of claim 1, wherein said locking mechanism is configured such that it is openable magnetically and the tool includes a magnet.

4. The system of claim 2, wherein a first of said first locking element and said second locking element is a plug and a second of said first locking element and said second locking element is a receptacle for said plug; and, said plug is inserted into said receptacle.

5. The system of claim 1, wherein said first component includes a control unit for an electric motor of the electric bicycle.

6. The system of claim 1, wherein said second component is a frame element of the electric bicycle.

7. The system of claim 1, wherein the system is configured such that, by opening said locking mechanism, said first component is detachable from said second component or vice versa.

8. The system of claim 1, wherein a receptacle for the first component is provided in said second component; and, said first component is arranged in said receptacle of said second component.

9. The system of claim 8, wherein a first of said first component and said second component has a tensioned spring element which bears against a second of said first component and said second component and thereby holds said first component in said receptacle of said second component, and when the locking mechanism is opened, pushes said first component out of said receptacle of said second component so that said first component is removable from said receptacle.

10. The system of claim 9, wherein:
said spring element is a spring arm on said first component;
said receptacle defines an opening through which said first component is inserted into said receptacle;
said opening is surrounded laterally and bounded by a section of said second component; and,
said spring arm extends at least partially under said section of said second component, bears on said section and is thereby tensioned.

11. The system of claim 1, wherein elements of said locking mechanism are not freely visible.

12. The system of claim 1, wherein:
said locking mechanism includes a plurality of first locking elements at different first locations on said first component and a plurality of second locking elements at second locations on said second component that match said first locations;
said plurality of first locking elements are coupled with said plurality of second locking elements; and,
said locking mechanism is configured to be opened by a tool having an arrangement of magnets which corresponds to the arrangement of said plurality of first locking elements and said plurality of second locking elements.

13. An electric bicycle comprising the system of claim 1.

14. A component for an electric bicycle, the component comprising:
a locking element for coupling with a further locking element of a further component;
said locking element being provided for a locking mechanism which, when closed, connects two components to each other via a coupling between said locking element and said further locking element; and,
said locking mechanism being configured to be opened via at least one of a magnetic field and an electric field provided by a tool.

15. A kit for an electric bicycle, the kit comprising:
a first component having a first locking element;
a second component having a second locking element;
said first locking element and said second locking element forming part of a locking mechanism which is configured such that said locking mechanism is closable by coupling said first locking element and said second locking element and, in a closed state, decoupling of said first locking element and said second locking element is blocked; and,
said locking mechanism being configured to be opened via at least one of a magnetic field and an electric field provided by a tool.

16. A method for assembling a system for an electric bicycle, the method comprising: providing the kit of claim 15; and,
coupling the first locking element and the second locking element to each other to connect the first component and the second component to each other.

17. A method for disassembling a system for an electric bicycle, the method comprising:
providing the system of claim 1;
positioning the tool over at least one of the first component and the second component; and,
detaching the first component from the second component or vice versa.
